(19) United States
(12) Patent Application Publication
(10) Pub. No.: US 2006/0106871 A1
(43) Pub. Date: May 18, 2006

(54) Systems and methods for improving corporate compliance

(76) Inventors: Thomas Dean Burrell, Barrington, IL (US); Timothy J. Wais, Chicago, IL (US)

Correspondence Address: Mr. Marc D. Machtinger, Esq.;Law Office of Marc D. Machtinger, Ltd., Suite 350, 750 W. Lake Cook Road, Buffalo Grove, IL, 60089-2073, US

(21) Appl. No.: 10/990,238

(22) Filed: Nov. 16, 2004

(51) Int. Cl. G06F 17/00

(52) U.S. Cl. 707/104.1

(57) ABSTRACT

Methods and systems for improving compliance to corporate initiatives are disclosed. According to the present invention, the system combines software for personnel of a corporate enterprise to communicate securely over a computer network, software for entering and storing information regarding corporate initiatives, software communicating the information to the corporate enterprise personnel, and software for the corporate enterprise personnel to communicate compliance with the corporate initiatives. The system can also include software for communicating information to suppliers to the corporate enterprise, software for the suppliers to communicate availability of materials compliant with the corporate initiatives to corporate enterprise employees, and software for the corporate enterprise employees to request the materials from the suppliers. The system can also include hardware and software for tracking the compliant materials.

### BACKGROUND OF THE INVENTION

1. Field of the Invention

The present invention relates to compliance with corporate initiatives. Specifically, the present invention relates to computer based systems and methods to improve compliance with corporate initiatives.

2. Description of the Related Art

For a large number of corporate enterprises a great deal of time, effort, and expense is spent just trying to make sure corporate initiatives are followed. These costs not only have a negative impact on the bottom line, but they have a multiplying effect on the negative impact in that the failures to comply with corporate initiatives often have the additional negative effect of decreased revenues. The problems are compounded in situations where corporate initiatives are planned at a home office or headquarters and then rolled out to field personnel. For example, a large retail enterprise spends many millions of dollars planning product promotions. These product promotions often include the coordination of in store displays, layouts, pricing plans and advertising materials. Product promotion plans of this type are typically designed so the customer receives a consistent message throughout the advertising, purchase and post purchase process. Often these plans are fine tuned to such a degree that they include where place products, signage and displays within a store. When the plans are not followed, the result is lower sales and increased costs.

There are many reasons why the corporate initiatives are not followed. However, the most common reasons involve lack of proper communication and follow up regarding the plans. Generally speaking, the employees want to comply with the initiatives, but often lack the information they need to comply. Some attempts have been made to address this or related issued.

For example, published U.S. Patent Application, Pub. No. US 2003/0069983, discloses web based methods and systems for managing compliance assurance information. The system employs a server system coupled to a centralized interactive database and at least one client system. The method includes receiving compliance assurance (CA) information from a client system, storing CA information in a centralized database, cross-referencing CA information, updating the centralized database periodically to maintain CA information, providing CA information in response to an inquiry, and notifying users electronically of CA tasks and CA deadlines. These systems and methods are generally directed towards maintaining records for the business entity such that the entity can prove that it is complying with applicable laws and regulations and internal standards and policies.

Another example is disclosed in published U.S. Patent Application, Pub. No. US 2004/0019500, which discloses systems and methods for providing corporate governance-related services. The systems and methods include receiving information from a service provider, and facilitating compliance with the corporate governance standards for at least one of an accounting service, a legal service, an insurance service, a health, medical, and welfare benefit service, and a government regulatory service. Again, these systems and methods are directed towards maintain the proper records so an entity can prove compliance.

Published U.S. Patent Application, Pub. No. US 20003/0069782 discloses systems and methods for scheduling and tracking retail store resets and remodels. The systems and methods electronically manage store resets and remodels wherein users enter product information, labor information, and labor requirements. Store activity is then managed upon receiving requests. The amount of labor needed to perform the store activity is automatically determined and parties are electronically notified of the pending store activity. Upon completion of the store reset or remodel, feedback is submitted by parties contributing labor, and invoices are automatically generated. Generally, these method and systems are designed to track construction projects.

Published U.S. Patent Application, Pub. No. US 20003/0120528 discloses systems and methods for managing compliance with strategic business rules. The method includes storing procurement data concerning historical procurement events in a procurement data warehouse. The method further includes storing one or more business compliance rules specifying conditions for a particular procurement event to be compliant. The method further includes automatically analyzing a portion of the procurement data related to the particular procurement event to determine whether or not the particular procurement event is compliant according to the one or more business compliance rules. The method further includes automatically generating visual output based on whether or not the particular procurement event is determined compliant.

Lastly, Published U.S. Patent Application, Pub. No. US 20001/0049615 discloses a method and apparatus for dynamic business management. One embodiment includes a method for workforce procurement and management using a hosted network application. The method comprises maintaining a plurality of modules accessible at varying levels to different participants in a workforce procurement and management process. Generally, the method and apparatus are designed to track labor needs and available labor resources.

There remains a need for a comprehensive computer network based system developed to support field personnel in managing corporate initiatives and allow home office personnel to monitor these efforts. Thus, it would be advantageous to provide a system developed to support field personnel in managing corporate initiatives and allow home office personnel to monitor these efforts.

### SUMMARY

In view of the deficiencies described above, it is an object of the present invention to provide a system developed to support field personnel in managing corporate initiatives and allow home office personnel to monitor these efforts.

The present invention includes methods and systems for improving compliance to corporate initiatives. According to the present invention, the system combines software for personnel of a corporate enterprise to communicate securely over a computer network, software for entering and storing information regarding corporate initiatives, software communicating the information to the corporate enterprise personnel, and software for the corporate enterprise personnel to communicate compliance with the corporate initiatives.

The software allows corporate enterprise personnel at various levels of the corporate enterprise to manage compliance with the corporate initiatives. The corporate initiatives can include, but are not limited to, promotional activities, human resource activities, layout plans, training plans, pricing plans, and the like. The various levels of the corporate enterprise can include, but are not limited, to home office or headquarter personnel and field personnel.

In various preferred embodiments, the system can also include software for communicating information to suppliers to the corporate enterprise and software for the suppliers to communicate availability of materials compliant with the corporate initiatives to corporate enterprise employees. In further preferred embodiments the system can also include software for the corporate enterprise employees to request the materials from the suppliers.

In other various preferred embodiments, the system can include software for tracking compliance with said corporate initiatives. Tracking compliance can include, but is not limited to, tracking compliance rates, tracking time to compliance, tracking compliance by person, tracking compliance by store, tracking compliance by store type, tracking compliance by geographic region, tracking compliance by organization.

In other preferred embodiments, the system includes hardware and software for tracking the compliant materials. The hardware and software can include location tracking devices operatively associated with the materials, location tracking monitors to monitor the location tracking devices, and software for communicating the location of the materials. This location tracking can include, but is not limited to, tracking materials from vendors to stores or tracking materials from the home office to stores. In some embodiments, management can even track where the materials are within a store, for example, are the materials in a store room, or in the intended location in the store front. The location tracking and monitoring devices can include, but are not limited to radio frequency identification (RFID) tags and detectors. Other location tracking and monitoring technology may also be used.

Other features and advantages of the invention will be apparent from the following detailed description taken in conjunction with the following figures, wherein like reference numerals represent like features.

### BRIEF DESCRIPTION OF THE DRAWINGS

FIG. 1 shows a representation of the present invention in block diagram form.

FIG. 2 shows an embodiment of the material location tracking aspect of the present invention.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

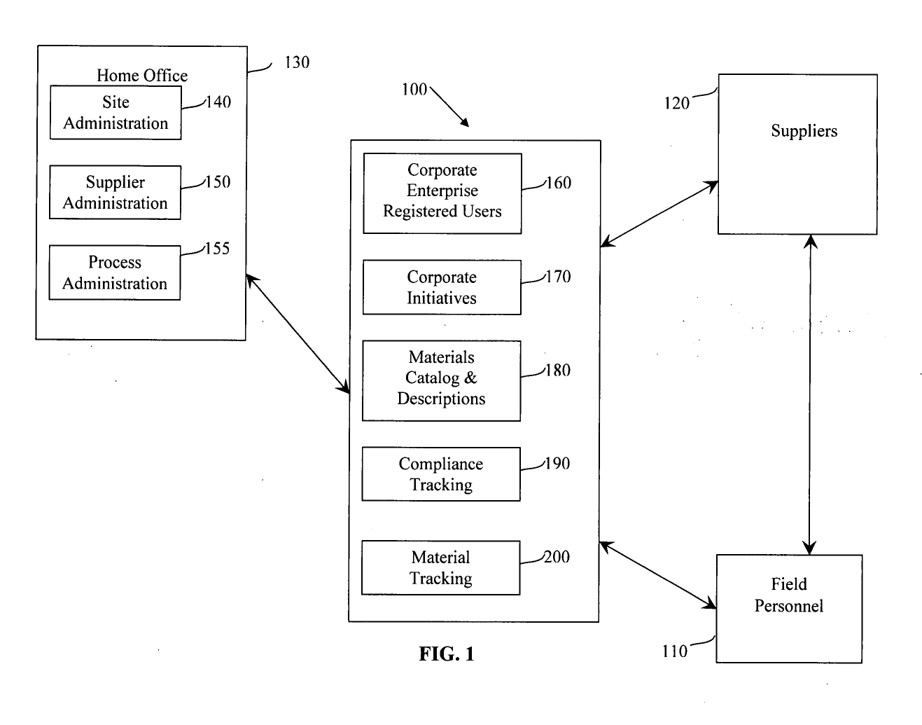

The present invention is a computer network based system for improving compliance to corporate initiatives. FIG. 1 shows a representation of the present invention in block diagram form. The system 100 combines software for personnel 160 of a corporate enterprise to communicate securely over a computer network, software for entering and storing information regarding corporate initiatives 170, software communicating the information to the corporate enterprise personnel 160, and software for the corporate enterprise personnel 160 to communicate compliance with the corporate initiatives 170. In various preferred embodiments the computer network is the World Wide Web, commonly referred to as the Internet.

The system 100 allows corporate enterprise personnel 160 at various levels of the corporate enterprise to manage compliance with the corporate initiatives 170. The corporate initiatives 170 can include, but are not limited to, promotional activities, human resource activities, layout plans, training plans, pricing plans, and the like. The various levels of the corporate enterprise can include, but are not limited, to home office 130 personnel and field personnel 110. For example, a corporate enterprise may be planning a new promotion, where the new promotion includes floor displays, promotional pricing, and window signage. In this example, a manager at the home office 130 could not only communicate the information related to the promotion to the appropriate field personnel 10 using the present invention, but the field personnel 110 can also confirm receipt of the information as well as acknowledge that they have received the displays and signage and that the displays and signage are properly displayed.

In various preferred embodiments, the system 100 can also include software for communicating information to suppliers 120 to the corporate enterprise and software for the suppliers 120 to communicate availability of materials 180 compliant with the corporate initiatives 170 to corporate enterprise employees 160. In further preferred embodiments the system 100 can also include software for the corporate enterprise employees 160 to request the materials 180 from the suppliers 120. The materials 180 can include sets of materials 180 or component parts thereof. Continuing the example from above, suppliers 120 of the promotional materials 180 can be notified of the types and quantities of materials 180 that will be required for the promotion. The suppliers 120 can then communicate that they have the materials 180 available. Additionally, if a particular store does not receive the right materials 180, the field personnel 110 can communicate directly with the suppliers 120 to make sure that the material 180 is received in time for the promotion. Furthermore, a particular store may be able to request a particular component of the materials 180 without having to request an entire material 180 package.

In other various preferred embodiments, the system 100 can include software for tracking compliance 190 with said corporate initiatives 170. Tracking compliance 190 helps managers focus their attentions to areas where compliance performance needs improvement. Tracking compliance 190 can include, but is not limited to, tracking compliance rates, tracking time to compliance, tracking compliance by person, tracking compliance by store, tracking compliance by store type, tracking compliance by geographic region, tracking compliance by organization.

In one preferred embodiment, software interfaces are provided for home office 130 personnel, which can include interfaces for site administration 140 and process administration 150, field personnel 110, and suppliers 120. Corporate enterprise personnel 160 can log on to the system 100 though any internet web browser and have access to schedules of upcoming initiatives 170, detailed descriptions of the initiatives 170, catalogs of compliant materials 180, and detailed descriptions of the materials 180. The home office 130 has available, in detail or in summary, filtered, real-time reporting of all compliance tracking 190 measures, including, but not limited to, orders being placed by the field personnel 110, timelines and compliance by the field with the initiatives 170, status of the initiatives 170, and supplier 120 performance.

The site administrator 140 has a top level security model that give full administration rights to a use on the back-end of the system 100. Any updates made by the site administrator 140 can be immediately activated without further approval. The site administrator 140 can have over-site of all administrative users and can have final approval over administrative updates.

The process administrator 150 can have rights for performing process-related functions on the back end of the system 100. For example, the process administrator 150 can add, delete, or edit items, categories or projects. The process administrator 150 can also approve products or orders.

Field personnel 110 are the front end users of the system 100. Field personnel 110 can place orders, check status or make inquires about the initiatives 170.

Furthermore, there can be supplier administrators 155 that perform supplier 120 related functions, which may include, but are not limited to, confirming orders, adding initiative 170 descriptions, adding materials 180 descriptions, or shipping orders.

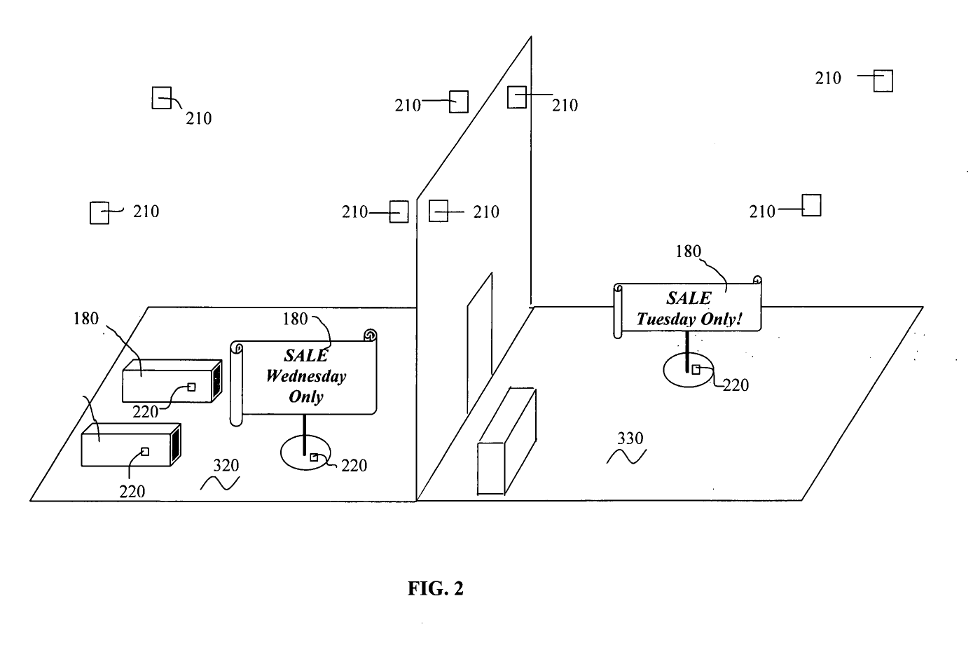

In other preferred embodiments, the system includes hardware and software for tracking the compliant materials 180. FIG. 2 shows an embodiment of the material location tracking aspect of the present invention. The hardware and software can include location tracking devices 220 operatively associated with the materials 180, location tracking monitors 210 to monitor the location tracking devices 220, and material tracking 200 software for communicating the location of the materials 180. This feature allows management to further assure and improve compliance to corporate initiatives 170 by having independent confirmation that the compliant materials 180 are at the intended location, for example management can confirm that the materials 180 arrived at a store 310. This location tracking can include, but is not limited to, tracking materials 180 from suppliers 120 to stores 310 or tracking materials 180 from the home office 130 to stores 310. In some embodiments, management can even track where the materials 180 are within a store 310, for example, are the materials 180 in a store room 320, or in the intended location in the store front 330. The location tracking 220 and monitoring 210 devices can include, but are not limited to radio frequency identification (RFID) tags and detectors. Other location tracking and monitoring technology may also be used.

The present invention also includes methods of improving compliance to corporate initiatives. The methods include communicating securely over a computer network connecting corporate enterprise personnel 160, entering and storing information regarding corporate initiatives 170, communicating the information to the corporate enterprise personnel 160, and communicating compliance with the corporate initiatives 170. The methods can also include communicating the information to suppliers 120 to the corporate enterprise, and communicating the availability of materials 180 compliant with the corporate initiatives 170 from the supplier 120 to the corporate enterprise employees 160. In various preferred embodiments, the methods include requesting the materials 180 from the suppliers 120.

In other various preferred embodiments, the methods include tracking compliance 190 with the corporate initiatives 170. Tracking compliance 190 with the corporate initiatives 170 can include, but is not limited to, tracking compliance rates, tracking time to compliance, tracking compliance by person, tracking compliance by store, tracking compliance by geographic region, tracking compliance by store type, or tracking compliance by organization.

In other various preferred embodiments, the methods include tracking the compliant materials. Material tracking 200 can include, but is not limited to, associating a tracking device 220 with the materials 180, monitoring the location tracking devices 220, and communicating the location of the materials. The location tracking and devices 220 can include, but are not limited to, RFID tags. Material tracking 200 can include, but is not limited to, tracking the materials 180 from suppliers 120 to stores 310, tracking the materials 180 from a home office 130 to stores 310, or tracking the materials 180 within a store 310.

While specific embodiments have been illustrated and described, numerous modifications come to mind without significantly departing from the spirit of the invention and the scope of protection is limited by the scope of the accompanying claims.

What is claimed is:

1. A computer network based system for improving compliance to corporate initiatives comprising:
software enabled means for personnel of a corporate enterprise to communicate securely over a computer network,
software enabled means for entering and storing information regarding corporate initiatives,
software enabled means for communicating said information to said corporate enterprise personnel,
software enabled means for said corporate enterprise personnel to communicate compliance with said corporate initiatives.

2. The computer based system for improving compliance to corporate initiatives according to claim 1 further comprising:
software enabled means for communicating said information to suppliers to said corporate enterprise, and
software enabled means for said suppliers to communicate availability of materials compliant with said corporate initiatives to said corporate enterprise employees.

3. The computer based system for improving compliance to corporate initiatives according to claim 2 wherein said materials comprise display materials.

4. The computer based system for improving compliance to corporate initiatives according to claim 2 wherein said materials further comprises component parts of said display materials.

5. The computer based system for improving compliance to corporate initiatives according to claim 2 wherein said materials comprise promotional materials.

6. The computer based system for improving compliance to corporate initiatives according to claim 2 wherein said materials comprise human resources materials.

7. The computer based system for improving compliance to corporate initiatives according to claim 2 further comprising:
software enabled means for said corporate enterprise employees to request said materials from said suppliers.

8. The computer based system for improving compliance to corporate initiatives according to claim 1 further comprising:
software enabled means for tracking compliance with said corporate initiatives.

9. The computer based system for improving compliance to corporate initiatives according to claim 1 wherein said corporate enterprise personnel comprise home office personnel and field personnel

10. The computer based system for improving compliance to corporate initiatives according to claim 1 wherein said corporate initiatives comprise promotional plans.

11. The computer based system for improving compliance to corporate initiatives according to claim 1 wherein said corporate initiatives comprise layout plans for stores.

12. The computer based system for improving compliance to corporate initiatives according to claim 1 wherein said corporate initiatives comprise pricing plans.

13. The computer based system for improving compliance to corporate initiatives according to claim 1 wherein said corporate initiatives comprise human resources initiatives.

14. The computer based system for improving compliance to corporate initiatives according to claim 1 wherein said corporate initiatives comprise employee training plans.

15. The computer based system for improving compliance to corporate initiatives according to claim 8 wherein said software enabled means for tracking compliance with said corporate initiatives comprises software enabled means for tracking compliance rates.

16. The computer based system for improving compliance to corporate initiatives according to claim 8 wherein said software enabled means for tracking compliance with said corporate initiatives comprises software enabled means for tracking time to compliance.

17. The computer based system for improving compliance to corporate initiatives according to claim 8 wherein said software enabled means for tracking compliance with said corporate initiatives comprises software enabled means for tracking compliance by person.

18. The computer based system for improving compliance to corporate initiatives according to claim 8 wherein said software enabled means for tracking compliance with said corporate initiatives comprises software enabled means for tracking compliance by store.

19. The computer based system for improving compliance to corporate initiatives according to claim 8 wherein said software enabled means for tracking compliance with said corporate initiatives comprises software enabled means for tracking compliance by geographic region.

20. The computer based system for improving compliance to corporate initiatives according to claim 8 wherein said software enabled means for tracking compliance with said corporate initiatives comprises software enabled means for tracking compliance by store type.

21. The computer based system for improving compliance to corporate initiatives according to claim 8 wherein said software enabled means for tracking compliance with said corporate initiatives comprises software enabled means for tracking compliance by organization.

22. The computer based system for improving compliance to corporate initiatives according to claim 2 further comprising:
means for tracking said materials compliant with said corporate initiatives.

23. The computer based system for improving compliance to corporate initiatives according to claim 22 wherein said means for tracking said materials compliant with said corporate initiatives comprises:
location tracking devices operatively associated with said materials,
location tracking monitors to monitor said location tracking devices, and
software enabled means for communicating the location of said materials.

24. The computer based system for improving compliance to corporate initiatives according to claim 23 wherein said location tracking devices comprise RFID tags and said location tracking monitors comprise RFID detectors.

25. The computer based system for improving compliance to corporate initiatives according to claim 22 wherein said means for tracking said materials compliant with said corporate initiatives comprises means for tracking said materials from vendors to stores.

26. The computer based system for improving compliance to corporate initiatives according to claim 22 wherein said means for tracking said materials compliant with said corporate initiatives comprises means for tracking said materials from a home office to stores.

27. The computer based system for improving compliance to corporate initiatives according to claim 22 wherein said means for tracking said materials compliant with said corporate initiatives comprises means for tracking said material within a store.

28. A method of improving compliance to corporate initiatives comprising:
communicating securely over a computer network connecting corporate enterprise personnel,
entering and storing information regarding corporate initiatives,
communicating said information to said corporate enterprise personnel,
communicating compliance with said corporate initiatives.

29. The method of improving compliance to corporate initiatives according to claim 28 further comprising:
communicating said information to suppliers to said corporate enterprise, and
communicating the availability of materials compliant with said corporate initiatives from said supplier to said corporate enterprise employees.

30. The method of improving compliance to corporate initiatives according to claim 29 wherein said materials comprise display materials.

31. The method of improving compliance to corporate initiatives according to claim 29 wherein said materials further comprises component parts of said display materials.

32. The method of improving compliance to corporate initiatives according to claim 29 wherein said materials comprise promotional materials.

33. The method of improving compliance to corporate initiatives according to claim 29 wherein said materials comprise human resources materials.

34. The method of improving compliance to corporate initiatives according to claim 29 further comprising:
requesting said materials from said suppliers.

35. The method of improving compliance to corporate initiatives according to claim 29 further comprising:
tracking compliance with said corporate initiatives.

36. The method of improving compliance to corporate initiatives according to claim 29 wherein said corporate enterprise personnel comprise home office personnel and field personnel

37. The method of improving compliance to corporate initiatives according to claim 29 wherein said corporate initiatives comprise promotional plans.

38. The method of improving compliance to corporate initiatives according to claim 29 wherein said corporate initiatives comprise layout plans for stores.

39. The method of improving compliance to corporate initiatives according to claim 29 wherein said corporate initiatives comprise pricing plans.

40. The method of improving compliance to corporate initiatives according to claim 29 wherein said corporate initiatives comprise human resources initiatives.

41. The method of improving compliance to corporate initiatives according to claim 29 wherein said corporate initiatives comprise employee training plans.

42. The method of improving compliance to corporate initiatives according to claim 35 wherein tracking compliance with said corporate initiatives comprises tracking compliance rates.

43. The method of improving compliance to corporate initiatives according to claim 35 wherein tracking compliance with said corporate initiatives comprises tracking time to compliance.

44. The method of improving compliance to corporate initiatives according to claim 35 wherein tracking compliance with said corporate initiatives comprises tracking compliance by person.

45. The method of improving compliance to corporate initiatives according to claim 35 wherein tracking compliance with said corporate initiatives comprises tracking compliance by store.

46. The method of improving compliance to corporate initiatives according to claim 35 wherein tracking compliance with said corporate initiatives comprises tracking compliance by geographic region.

47. The method of improving compliance to corporate initiatives according to claim 35 wherein tracking compliance with said corporate initiatives comprises tracking compliance by store type.

48. The method of improving compliance to corporate initiatives according to claim 35 wherein tracking compliance with said corporate initiatives comprises tracking compliance by organization.

49. The method of improving compliance to corporate initiatives according to claim 29 further comprising:
tracking said materials compliant with said corporate initiatives.

50. The method of improving compliance to corporate initiatives according to claim 49 wherein said tracking said materials compliant with said corporate initiatives comprises:
associating a tracking device with said materials,
monitoring said location tracking devices, and
communicating the location of said materials.

51. The method of improving compliance to corporate initiatives according to claim 50 wherein said location tracking devices comprise RFID tags.

52. The method of improving compliance to corporate initiatives according to claim 49 wherein tracking said materials compliant with said corporate initiatives comprises tracking said materials from vendors to stores.

53. The method of improving compliance to corporate initiatives according to claim 49 wherein tracking said materials compliant with said corporate initiatives comprises tracking said materials from a home office to stores.

54. The method of improving compliance to corporate initiatives according to claim 49 wherein tracking said materials compliant with said corporate initiatives comprises tracking said material within a store.
